(19) United States
(12) Patent Application Publication
(10) Pub. No.: US 2020/0036851 A1
(43) Pub. Date: Jan. 30, 2020

(54) Image Forming Apparatus, Medium Storing Program for Controlling Image Forming Apparatus, and Method of Controlling Image Forming Apparatus

(71) Applicant: Konica Minolta, Inc., Tokyo (JP)

(72) Inventors: Eisaku OWADA, Toyokawa-shi (JP); Taketoshi YAMAHATA, Toyokawa-shi (JP); Yoichi KURUMASA, Toyokawa-shi (JP)

(73) Assignee: Konica Minolta, Inc., Tokyo (JP)

(21) Appl. No.: 16/518,204

(22) Filed: Jul. 22, 2019

(30) Foreign Application Priority Data
Jul. 25, 2018 (JP) 2018-139120

(51) Int. Cl. H04N 1/00; H04N 1/44

(52) U.S. Cl. CPC H04N 1/00938; H04N 2201/0094; H04N 1/4433; H04N 1/00474

(57) ABSTRACT

An image forming apparatus includes: a receiver that receives an application from outside; and a controller for controlling the image forming apparatus. The controller performs operations including: executing the application received by the receiver, specifying a function of the application based on execution of the application; and outputting the specified function of the application in a state where the application is associated with the specified function of the application.

The entire disclosure of Japanese Patent Application No. 2018-139120 filed on Jul. 25, 2018 is incorporated herein by reference in its entirety.

### BACKGROUND

### Technological Field

The present disclosure relates to an image forming apparatus, a medium storing a program for controlling the image forming apparatus, and a method of controlling the image forming apparatus.

### Description of the Related Art

Recently, there is a known image forming apparatus to which an application including various functions can be downloaded from outside and used thereon, for the purpose of effectively utilizing the image forming apparatus. Such an image forming apparatus registers the downloaded application in a memory. This allows not only the user who has downloaded the application but also other users to use the registered application. However, as the number of the registered applications increases, the management of the registered application becomes complicated and troublesome. For addressing such a problem, the following plurality of methods have been proposed.

Japanese Laid-Open Patent Publication No. 2017-4552 discloses a terminal device and an application installation method thereof, by which the display position and the display manner of an identifier associated with an application are properly set so that a user can readily utilize the application.

Japanese Laid-Open Patent Publication No. 2012-231495 discloses a technique for, in response to an input of a program into an image forming apparatus through an I/F unit from an external network, determining whether a selection key for selecting and instructing a program input through input means can be further displayed or not on the first display screen (FIG. 14) showing a selection key associated with the program already registered in the image forming apparatus, and controlling the process of display on the display screen in accordance with the determination result.

### SUMMARY

According to the method disclosed in Japanese Laid-Open Patent Publication No. 2017-4552 or Japanese Laid-Open Patent Publication No. 2012-231495, a user can understand based on an icon and the like that the application obtained from outside has been registered, but the user cannot recognize the function of the application only by looking at an icon. In general, since an image forming apparatus is used in common among a lot of users, the person who has obtained an application from outside is not necessarily the same as the person who uses the application. When the application has been obtained from outside but when the user cannot understand what kind of function the application has, there occurs a problem that the application obtained from outside may not be sufficiently utilized in the image forming apparatus.

To achieve at least one of the above-mentioned objects, according to an aspect of the present invention, an image forming apparatus reflecting one aspect of the present invention comprises a receiver that receives an application from outside: and a controller for controlling the image forming apparatus. The controller performs operations including: executing the application received by the receiver; specifying a function of the application based on execution of the application; and outputting the specified function of the application in a state where the application is associated with the specified function of the application.

According to another embodiment, a non-transitory computer-readable recording medium storing a program for controlling an image forming apparatus is provided. The program causes a computer to perform; receiving an application front outside; executing the application received; specifying a function of the application based on execution of the application; and outputting the specified function of the application in a state where the application is associated with the specified function of the application.

According to another embodiment, a method of controlling an image forming apparatus is provided. The method includes: receiving an application from outside; executing the application received; specifying a function of the application based on execution of the application; and outputting the specified function of the application in a state where the application is associated with the specified function of the application.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1A is a diagram showing the manner in which an application is downloaded from an application store to an image forming apparatus according to the first embodiment.

FIG. 1B is a diagram showing an example of display on an operation panel showing the application downloaded to the image forming apparatus according to the first embodiment.

FIG. 2 is a block diagram showing the hardware configuration of the image forming apparatus according to the first embodiment.

FIG. 3 is a block diagram showing the structure of a controller of the image forming apparatus according to the first embodiment.

FIG. 4A is a diagram showing the manner in which a user is notified about a function of the application in the image forming apparatus according to the first embodiment.

FIG. 4B is a diagram showing the manner in which a user is notified about a function of the application in the image forming apparatus according to the first embodiment.

FIG. 4C is a diagram showing the manner in which a user is notified about a function of the application in the image forming apparatus according to the first embodiment.

FIG. 4D is a diagram showing the manner in which a user is notified about a function of the application in the image forming apparatus according to the first embodiment.

FIG. 5 is a block diagram showing the structure of a controller of an image forming apparatus according to the second embodiment.

FIG. 6 is a block diagram showing the structure of a controller of an image forming apparatus according to the third embodiment.

FIG. 7 is a diagram showing a table including a summary of the correspondence relation between the operation statuses of various sensors and the functions that are being executed.

FIG. 8 is a flow chart illustrating the process of specifying a function of an application in the third embodiment.

FIG. 9 is a block diagram showing the structure of a controller of an image forming apparatus according to the fourth embodiment.

FIG. 10 is a flowchart for illustrating the process in the controller of the image forming apparatus according to the fourth embodiment.

### DETAILED DESCRIPTION OF EMBODIMENTS

Hereinafter, one or more embodiments of the present invention will be described with reference to the drawings. However, the scope of the invention is not limited to the disclosed embodiments.

The embodiments will be hereinafter described in detail with reference to the accompanying drawings, in which the same or corresponding components are designated by the same reference characters, and description thereof will not be repeated.

### First Embodiment

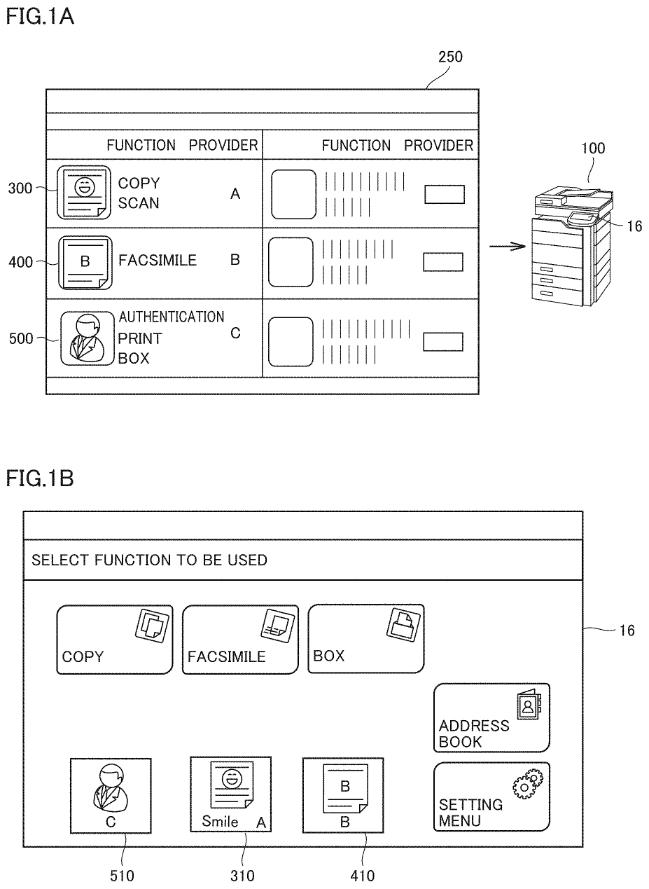

FIG. 1A is a diagram showing the manner in which an application is downloaded from an application store 250 to an image forming apparatus 100 according to the first embodiment. Application store 250 shown in FIG. 1A is a store on a network that provides an application with or without payment. Application store 250 provides applications including various functions. For example, an application 300 relates to a copy function and a scan function that are provided by company A. An application 400 relates to a facsimile function provided by company B. An application 500 relates to a function of performing authentication and printing and a function of performing authentication and storing and managing a document in electronic data format (a box function), which are provided by company C. A user can obtain an application that meets his/her needs from application store 250, and can download the obtained application to image forming apparatus 100 and use the downloaded application. The application used in image forming apparatus 100 is not limited to a application provided from a store over a network, but may be an application that is provided while being recorded on a storage medium such as compact disc read only memory (CD-ROM) or an application installed from another device through a universal serial bus (USB) cable or the like.

FIG. 1B is a diagram showing an example of display on an operation panel 16 showing applications 300, 400 and 500 downloaded to image forming apparatus 100 according to the first embodiment. An icon 310 shown in FIG. 1B is associated with application 300 downloaded to image forming apparatus 100. Icon 310 shows a character “A” as a name of the company that provides application 300, a word “Smile” as a slogan of company A, and a logo of company A.

An icon 410 shown in FIG. 1B is associated with application 400 downloaded to image forming apparatus 100. Icon 410 shows a character “B” as a name of the company that provides application 400.

An icon 510 shown in FIG. 1B is associated with application 500 downloaded to image forming apparatus 100. Icon 510 shows a character “C” as a name of the company that provides application 500 and a logo of company C.

In this way, the downloaded application is displayed by an icon and distinguished from other applications. However, at the point of time when the application is downloaded, the icon shows only the name, the logo, the slogan and the like of the company that provides the application. Accordingly, the user cannot recognize the function of the application only by looking at the icon. In general, the image forming apparatus is used in common among a lot of users. Thus, the person who has downloaded the application to the image forming apparatus is not necessarily the same as the person who uses the application. When the application has been downloaded but when the user is not notified about the type of the function included in the application, the application is not used, so that the image forming apparatus is not effectively utilized.

Accordingly, when an application is once executed, image forming apparatus 100 according to the first embodiment specifies the function of the application based on the application execution status, and registers the specified function in association with the application. Furthermore, image forming apparatus 100 notifies the user about the registered function by displaying the registered function on an icon of the associated application. In other words, once the downloaded application is executed, image forming apparatus 100 can notify the user about the function of the downloaded application.

In particular, in many cases, the user who has downloaded an application understands the function of the downloaded application and has an intention to use the application immediately. In this case, as the application is downloaded and used, the function of the application is immediately registered in image forming apparatus 100. As a result, the users other than the person who has downloaded the application can utilize image forming apparatus 100 after understanding the function of the application by a notification about the function through an icon and the like.

Then, the hardware configuration of image forming apparatus 100 according to the first embodiment will be described. Image forming apparatus 100 may be implemented in any form such as a multi-functional peripheral (MFP), a copier, a facsimile machine, and a printer.

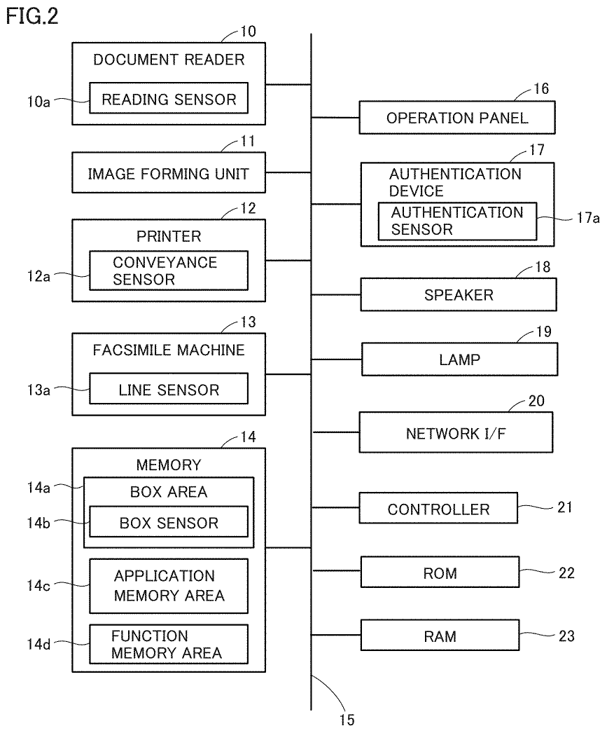

FIG. 2 is a block diagram showing the hardware configuration of image forming apparatus 100 according to the first embodiment. Referring to FIG. 2, image forming apparatus 100 serves as a multi-functional peripheral, and includes a document reader 10, an image forming unit 11, a printer 12, a facsimile machine 13, a memory 14, an operation panel 16, an authentication device 17, a speaker 18, a lamp 19, a network interface 20, a controller 21, a read only memory (ROM) 22, and a random access memory (RAM) 23, which are connected to one another through a bus 15.

Document reader 10 optically reads the image of the document fed from an automatic document feeder and the document placed on a glass plate, and transmits the read image to image forming unit 11. Document reader 10 includes a reading sensor 10a that senses reading of an image.

Using toner, image forming unit 11 implements formation of an image read by document reader 10 and an image received from other devices. Image forming unit 11 forms an image with black toner in the case of monochrome printing, and forms an image with four-color toner including yellow, magenta, cyan, and black in the ease of color printing.

Printer 12 prints the image formed by image forming unit 11 on a sheet of paper. Printer 12 includes a conveyance sensor 12a that senses passage of a sheet of paper.

Facsimile machine 13 transmits and receives image data to and from another facsimile machine through a telephone line. Facsimile machine 13 includes a line sensor 13a that senses the status of use of the telephone line.

Memory 14 includes a box area 14a, an application memory area 14c, and a function memory area 14d, and stores various pieces of information.

Box area 14a permanently or temporarily stores the image data on the document read by document reader 10 and the image data received from another device. In an aspect, box area 14a is used as a storage device for storing and managing the computerized information on a paper media. In another aspect, box area 14a is used as a transitory storage device for e-mail transmission of the image data on the document read by document reader 10 to another device. Box area 14a includes a box sensor 14b that senses storage of data in box area 14a.

Application memory area 14c stores the application obtained from the outside of image forming apparatus 100. For example, application memory area 14c stores the application downloaded from application store 250. In addition, when the application recorded on a CD-ROM is installed, and also when the application recorded on another device is installed through a USB cable or the like, application memory area 14c is used as an area in which the application is stored.

Function memory area 14d stores the function of the application stored in application memory area 14c in association with this application.

Operation panel 16 is a touch panel-type display showing various pieces of information such as an operation screen and allowing the user to perform a touch operation thereon.

Authentication device 17 verifies whether the user of image forming apparatus 100 is a valid user or not. For example, authentication device 17 requests the user to perform the operation for authentication when the user uses image forming apparatus 100. The operation for authentication may specifically be an input of an ID (identification) or a password into operation panel 16, an operation of holding an integrated circuit (IC) card over an IC card reader, an operation of holding a finger over a reader, and the like. When the user performs the operation for authentication, authentication device 17 verifies whether the user is a valid user or not based on the input details, the information embedded in the IC card or the biological information. Only the user who is determined as a valid user as a result of verification by authentication device 17 can use image forming apparatus 100.

Authentication device 17 includes an authentication sensor 17a that senses whether the operation for authentication has been performed or not by the user.

Speaker 18 gives a notification by a sound about the setting details, the operation procedure, the specified function of the application, and the like.

Lamp 19 lights up when the image data of the document read by document reader 10 or the image data received from another device is stored in box area 14a.

Network interface 20 serves as an interface through which image forming apparatus 100 is connected to a network, and may be a wired local area network (LAN), a wireless LAN, and the like. Network interface 20 is connected to another device, and is capable of receiving data for printing from another device and transmitting the image data of the document read by document reader 10 to another device.

Controller 21 is formed of a central processing unit (CPU) and the like. Controller 21 collectively controls the operations of components in image forming apparatus 100.

ROM 22 stores the control program for controlling the operation of image forming apparatus 100. RAM 23 serves as a working memory of controller 21.

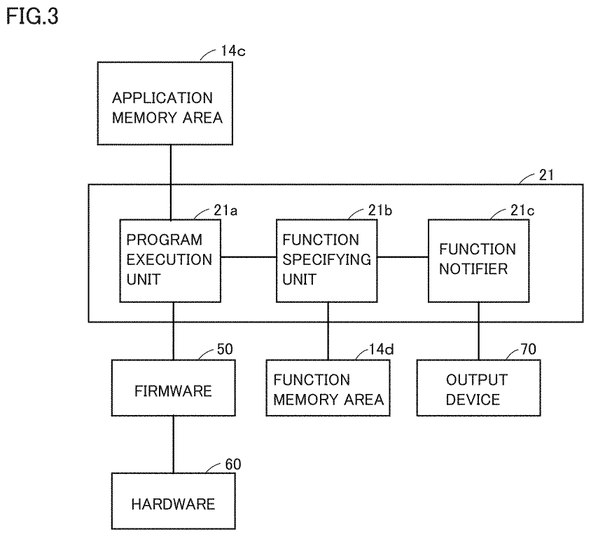

Then, the process performed by controller 21 of image forming apparatus 100 according to the first embodiment will be described. Controller 21 executes the program of the application, specifies the function of the application in the course of execution of the program, and notifies the user about the specified function in association with the application. FIG. 3 is a block diagram showing the structure of controller 21 of image forming apparatus 100 according to the first embodiment.

Controller 21 includes a program execution unit 21a that executes the program of the application, a function specifying unit 21b that specifies the function of the application, and a function notifier 21c that notifies a user about the function of the application. In the following, the process in each unit will be described.

First program execution unit 21a will be hereinafter described. When program execution unit 21a receives an instruction from a user to start execution of the application, it starts execution of the program of the application and performs the process based on the program. For example, when the user touches icon 310 on operation panel 16, program execution unit 21a starts execution of the program of application 300 stored in application memory area 14c. In the course of the process by program execution unit 21a, firmware 50 is accessed and each hardware 60 is started to operate to perform various functions related to image processing in image forming apparatus 100, such as a copy function, a print function, a scan function, a facsimile function, a box function, an authentication function.

Then, function specifying unit 21b will be described. As program execution unit 21a executes the program of the application, function specifying unit 21b specifics firmware 50, which is to be accessed, based on the program, and specifics the function associated with firmware 50 as the function of the application. After specifying the function, function specifying unit 21b registers the specified function in function memory area 14d in association with the application.

Firmware 50 is a control program stored in ROM 22. ROM 22 stores firmware 50 for each function, such as firmware for performing a copy function, firmware for performing a print function, firmware for performing a scan function, firmware for performing a facsimile function, firmware for performing a box function, and firmware for performing an authentication function. Firmware 50 associated with each function is accessed and executed, thereby performing each function. Accordingly, the function to be performed is specified depending on which function of firmware 50 is accessed. Thus, based on the description content of the program of the application, function specifying unit 21b specifies firmware 50 to be accessed, and specifies the function associated with firmware 50 as a function of the application.

For example, when the firmware for performing a copy function and the firmware for performing a scan function are described, as firmware 50 to be accessed, in the program of application 300 executed by program execution unit 21a, function specifying unit 21b specifies the function of application 300 as a copy function and a scan function. Function specifying unit 21b stores the specified copy function and the specified scan function in function memory area 14d in association with application 300. However, when the copy function and the scan function have already been associated with application 300 in function memory area 14d, function specifying unit 21b does not register each of the copy function and the scan function. Furthermore, when one of the copy function and the scan function is associated with application 300 and the other of these functions is not associated with application 300, the other function is further registered in function memory area 14d in association with application 300.

In this way, based on the program of the application that is executed by program execution unit 21a, image forming apparatus 100 according to the first embodiment specifies firmware 50 to be accessed, thereby specifying the function of the application.

Furthermore, image forming apparatus 100 according to the first embodiment registers a function among the specified functions, which is not associated with the application in function memory area 14d, in function memory area 14d newly in association with the application. Thereby, even the function that has not been performed during previous execution of the application but that has been performed by current execution of the application is additionally registered in function memory area 14d.

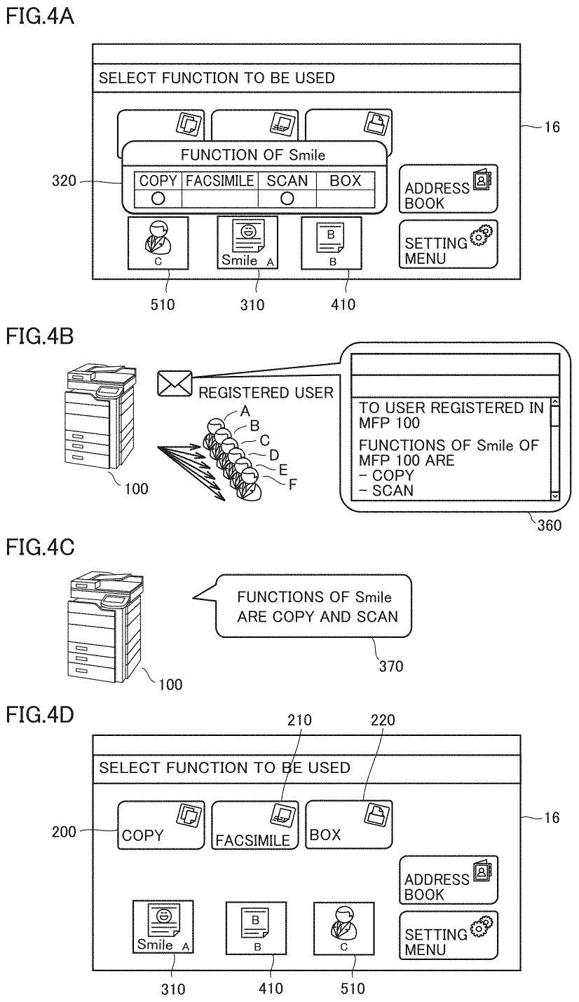

Then, function notifier 21c will be hereinafter described. Function notifier 21c notifies a user through an output device 70 about the function of the application that is specified by function specifying unit 21b and registered in function memory area 14d. Output device 70 includes operation panel 16, network interface 20 or speaker 18. Various manners of notifications can be conceivable. In this case, an explanation will be given with regard to examples of a notification on operation panel 16, a notification by an e-mail through network interface 20, and a notification by a sound through speaker 18. FIGS. 4A, 4B, 4C, and 4D each are a diagram showing the manner in which a user is notified about the function of the application in image forming apparatus 100 according to the first embodiment.

Referring to FIG. 4A, an explanation will be hereinafter given with regard to an example in which the function of the application is displayed on operation panel 16. In FIG. 4A, a pop-up screen 320 is displayed in the vicinity of icon 310 associated with application 300. Pop-up screen 320 shows the name of application 300 referred to as “Smile” and the names of functions such as copy, facsimile, scan, and box. Also, a round mark “O” is shown below each of titles of copy and scan as functions of application 300.

In this way, function notifier 21c causes the function of application 300 that is specified by function specifying unit 21b and registered in function memory area 14d to be displayed as a pop-up screen in the vicinity of icon 310 on operation panel 16. The pop-up screen shows all of the functions of application 300 that are specified by function specifying unit 21b and registered in function memory area 14d. Thereby, only by looking at pop-up screen 320, the user can understand the function of application 300. As a result, not only the person who has downloaded the application but also another user other than this person can select his/her desired application after understanding the function of each application.

Furthermore, function notifier 21c may causes pop-up screen 320 to be displayed in response to touching of icon 310 by the user or may cause pop-up screen 320 to be continuously displayed together with icon 310 on operation panel 16. Furthermore, in response to touching of icon 310 by the user, function notifier 21c may give a notification about the function by a sound in addition to pop-up screen 320. Furthermore, pop-up screen 320 displayed by function notifier 21c only has to be displayed so as to allow the user to recognize the function of application 300, but is not limited to those shown in FIG. 4A.

Referring to FIG. 4B, an explanation will be hereinafter given with regard to an example in which a notification about the function of the application is given by an e-mail. A notification by an e-mail is given through network interface 20. Each of registered users A to F shown in FIG. 4B is registered in advance in image forming apparatus 100 as a destination to which the notification about the function of application 300 is given. A balloon 360 shows the text of the e-mail transmitted from image forming apparatus 100 to registered users A to F. The text of the e-mail includes the content that the application 300 referred to as “Smile” has been added, and also includes the functions (a copy function and a scan function) of application 300.

In this way, through an e-mail, function notifier 21c notifies the registered user about the function of application 300, which is specified by function specifying unit 21b and registered in function memory area 14d, in association with application 300. The e-mail describes all of the functions of application 300 that are specified by function specifying unit 21b and registered in function memory area 14d. Thereby, the user can recognize that application 300 has been added, and also can recognize its function. As a result, not only the person who has downloaded the application but also another user other than this person can select his/her desired application after understanding the function of each application.

Furthermore, the content of the e-mail given by function notifier 21c only have to allow the user to understand the function of application 300, but is not limited to that shown in FIG. 4B.

Referring to FIG. 4C, an explanation will be hereinafter given with regard to an example in which a notification about the function of the application is given by a sound. A notification by a sound is given through speaker 18. A balloon 370 shown in FIG. 4C show's the content given by a sound. In FIG. 4C, after the user uses application 300, a notification is given by a sound stating that the used function of application 300 referred to as “Smile” includes a copy function and a scan function.

In this way, function notifier 21c gives a notification by a sound about the function of application 300, which is specified by function specifying unit 21b and registered in function memory area 14d, in association with application 300. Notification about all of the functions of application 300 that are specified by function specifying unit 21b and registered in function memory area 14d is given by a sound. Thereby, by hearing the sound, another user other than the user who has executed application 300 can recognize that application 300 has been added, and also can recognize its function. As a result, not only the person who has downloaded the application but also another user other than this person can select his/her desired application after understanding the function of each application.

In FIG. 4C, a notification by a sound from function notifier 21c is given after the user uses application 300, but may be given while the user is using application 300. Function notifier 21c may give a notification about the function of application 300 only when the downloaded application is used for the first time. Alternatively, function notifier 21c may give a notification about the function of application 300 each time application 300 is used. Furthermore, the notification by a sound from function notifier 21c may be given in response to touching of icon 310 on operation panel 16 by the user. Furthermore, the content of the notification given by a sound from function notifier 21c only has to allow the user to understand the function of application 300, but is not limited to that shown in FIG. 4C.

Referring to FIG. 4D, an explanation will be hereinafter given with regard to an example in which icons associated with their respective applications are displayed on operation panel 16 in an arrangement organized according to functions. In FIG. 4D, icon 310 associated with application 300 having a copy function is arranged below an icon 200 of a copy function; icon 410 associated with application 400 having a facsimile function is arranged below an icon 210 of a facsimile function; and icon 510 associated with application 500 having a box function is arranged below an icon 220 of a box function.

In this way, based on the function of application 300 that is specified by function specifying unit 21b and registered in function memory area 14d, function notifier 21c organizes the arrangement of icons on operation panel 16 such that the functions of the same type are located in the same column. The arrangement of the icons is changed based on all of the functions of application 300 that are specified by function specifying unit 21b and registered in function memory area 14d. Thereby, the user can recognize that application 300 has been added and also can recognize its function. As a result, not only the person who has downloaded the application but also another user other than this person can select his/her desired application after understanding the function of each application.

Furthermore, function notifier 21c may arrange the icons having the functions of the same type to be located in the same column or in the same row on operation panel 16. The icons only have to be arranged so as to allow the user to recognize the function of the application associated with an icon based on the arrangement of the icons.

In this way, image forming apparatus 100 according to the first embodiment notifies the user about the function of the application, which is specified by function specifying unit 21b, in association with the application. Also, function notifier 21c may optionally combine the examples of notifications shown in FIGS. 4A, 4B, 4C, and 4D. Furthermore, the method of notifying the user about the function of the application only has to allow the user to be notified about the function of the application, but is not limited to those shown in FIGS. 4A, 4B, 4C, and 4D.

As above, image forming apparatus 100 according to the first embodiment has been described. According to the first embodiment, the function of the application is specified based on the description content of the program of the application, and the user is notified about the specified function in association with the application. As a result, not only the person who has downloaded the application but also another user other than this person can select his/her desired application after understanding the function of each application.

### Second Embodiment

Then, the second embodiment will be hereinafter described. The second embodiment is different from the first embodiment in the method of specifying the function of the application in a function specifying unit 21c. Other than the above, the second embodiment is identical to the first embodiment also in the configuration of image forming apparatus 100. In the first embodiment, firmware 50 to be accessed is specified based on the description content of the program of the application, and the function associated with firmware 50 is specified as the function of the application. On the other hand, in the second embodiment, firmware 50 to be accessed is specified based on the application programming interlace (API) invoked during execution of the program of the application, and the function associated with firmware 50 is specified as the function of the application.

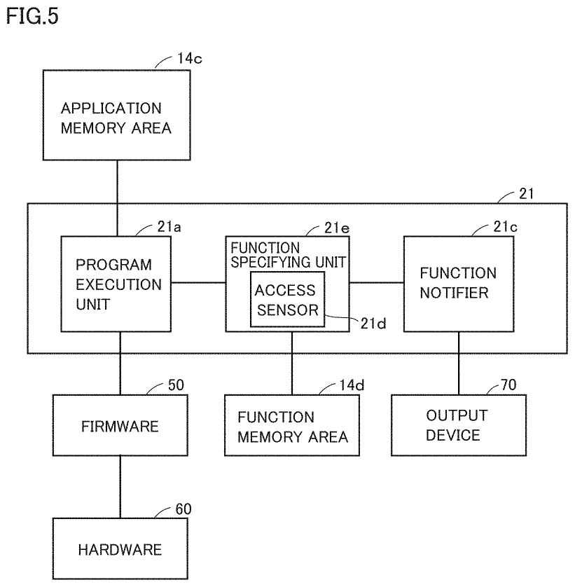

FIG. 5 is a block diagram showing the structure of a controller 21 of an image forming apparatus 100 according to the second embodiment. As shown in FIG. 5, controller 21 in the second embodiment includes a program execution unit 21a that executes the program of the application, a function specifying unit 21e ethat specifics the function of the application, and a function notifier 21c that notifies a user about the function of the application, as in the first embodiment. On the other hand, controller 21 in the second embodiment is different from that in the first embodiment in that function specifying unit 21c includes an access sensor 21d that senses the access to firmware 50. The following is an explanation about the process of specifying a function in function specifying unit 21c. The process of registering the specified function in function memory area 14d, the process performed in program execution unit 21a, and the process performed in function notifier 21c are the same as those in the first embodiment, and therefore, the description thereof will not be repeated.

Access sensor 21d in function specifying unit 21e senses the access to firmware. In order to sense the access to firmware, access sensor 21d monitors the API invoked as program execution unit 21a executes the program of the application.

The API screes as an interface through which firmware 50 associated with each function is operated, and is provided for each function. Examples of the API may be an API for copying through which the firmware associated with a copy function is executed; an API for printing through which the firmware associated with a print function is executed; an API for scanning through which the firmware associated with a scan function is executed; an API for facsimile through which the firmware associated with a facsimile function is executed, an API for box through which the firmware associated with a box function is executed; an API for authentication through which the firmware associated with an authentication function is executed; and the like. Accordingly, based on the type of the API that has been invoked, it becomes possible to specify as to which function of firmware 50 has been accessed. Thus, access sensor 21d monitors the API that is invoked as program execution unit 21a executes the program of the application, and determines that the firmware associated with the invoked API has been accessed. Function specifying unit 21c specifics the function, which is associated with firmware 50 determined by access sensor 21d as having been accessed, as the function of the application.

For example, in the case where the API for copying and the API for scanning are invoked when program execution unit 21a executes the program of application 300, access sensor 21d determines that the firmware for performing a copy function and the firmware for perforating a scan function have been accessed, and then, function specifying unit 21c specifics the function of application 300 as a copy function and a scan function.

In FIG. 5, access sensor 21d is provided in function specifying unit 21e and incorporated in advance in image forming apparatus 100. However, access sensor 21d may be provided in controller 21 separately from function specifying unit 21c. Furthermore, the mechanism of sensing access to firmware 50 may be provided by: the application downloaded from outside; the application provided while being recorded in a storage medium such as a CD-ROM; the application installed through a USB cable or the like from other devices; and the like.

Furthermore, access sensor 21d only has to be capable of sensing access to firmware 50 but is not limited to that monitors the API.

In this way, based on the API invoked when program execution unit 21a executes the program of the application, image forming apparatus 100 according to the second embodiment specifics firmware 50 to be accessed, thereby specifying the function of the application. Accordingly, image forming apparatus 100 according to the second embodiment can specify the function of the application even when firmware 50 to be accessed cannot be specified based on the description content of the program of the application.

As above, image forming apparatus 100 according to the second embodiment has been described. According to the second embodiment, as firmware 50 to be accessed is specified based on the API invoked during execution of the program of the application, the function of the application is specified, and then, the user is notified of the specified function in association with the application. As a result, not only the person who has downloaded the application but also another user other than this person can select his/her desired application after understanding the function of each application.

### Third Embodiment

Then, the third embodiment will be hereinafter described. The third embodiment is different from the first embodiment in the method of specifying the function of the application in a function specifying unit 21f. Other than the above, the third embodiment is identical to the first embodiment also in the configuration of image forming apparatus 100. In the first embodiment, firmware 50 to be accessed is specified based on the description content of the program of the application, and then, the function associated with firmware 50 is specified as the function of the application. On the other hand, in the third embodiment, the function of the application is specified based on the operation status of hardware 60 that is operated in accordance with execution of the application.

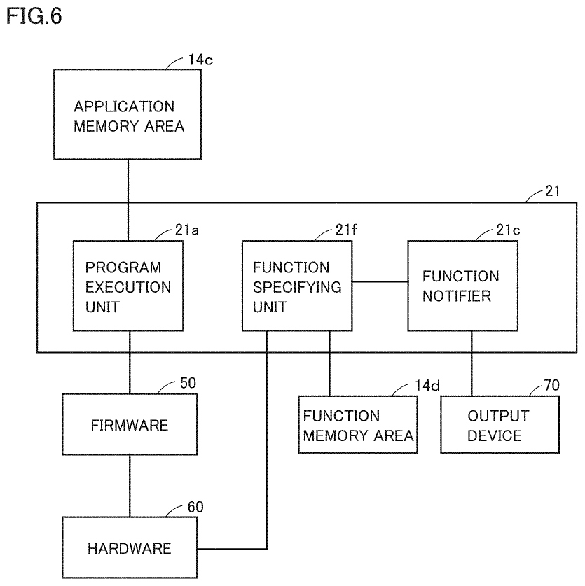

FIG. 6 is a block diagram showing the structure of a controller 21 of an image forming apparatus 100 according to the third embodiment. As shown in FIG. 6, controller 21 in the third embodiment includes: a program execution unit 21a that executes the program of the application; a function specifying unit 21f that specifics the function of the application; and a function notifier 21c that notifies a user about the function of the application, as in the first embodiment. On the other hand, controller 21 in the third embodiment is different from the first embodiment in that function specifying unit 21f is associated with hardware 60. The following is an explanation about the process of specifying a function in function specifying unit 21f. The process of registering the specified function in function memory area 14d, the process performed in program execution unit 21a, and the process performed in function notifier 21c are the same as those in the first embodiment, and therefore, the description thereof will not be repeated.

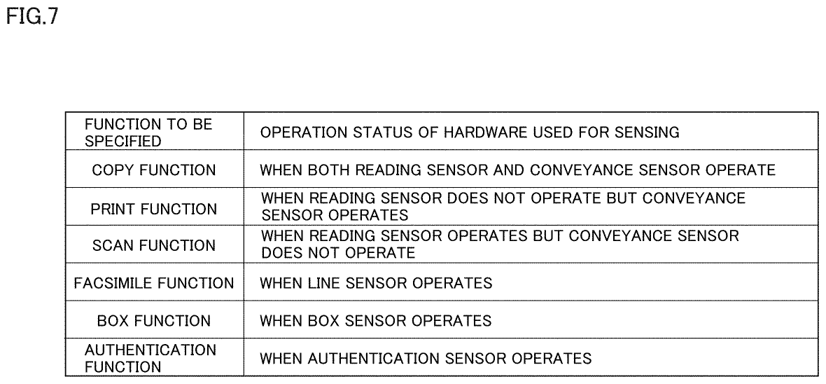

Function specifying unit 21f specifies the function of the application based on the operation status of hardware 60 that is operated in accordance with execution of the program of the application in program execution unit 21a after execution of the application is started. Hardware 60 may be various types of sensors, for example, shown in FIG. 7.

Referring to FIG. 7, the correspondence relation between the operation status of the sensor and the function that is being executed will be hereinafter described. FIG. 7 is a diagram showing a table including a summary of the correspondence relation between the operation statuses of various sensors and the functions that are being executed.

The sensors illustrated in FIG. 7 are divided into a sensor for sensing the job executed by image forming apparatus 100 and a sensor for sensing the authentication operation performed by a user. The sensor for sensing the job executed by image forming apparatus 100 may be reading sensor 10a, conveyance sensor 12a, line sensor 13a, and box sensor 14b. Also, the sensor for sensing the authentication operation performed by a user may be authentication sensor 17a.

Reading sensor 10a senses reading of a document image. Reading sensor 10a may be a charge coupled device (CCD) and the like, for example. The CCD detects the intensity of the light reflected from a document at the time when the document is read by document reader 10, and performs image processing. Thus, the CCD operates without fail when the document is read by document reader 10.

Conveyance sensor 12a senses conveyance of a sheet of paper. Examples of conveyance sensor 12a may be an optical sensor for sensing passage of a sheet of paper, and the like. In the case where the image of the document read by document reader 10 or the image received front another device is printed on a sheet of paper, conveyance sensor 12a reacts upon passage of the sheet of paper through a prescribed portion. Thus, conveyance sensor 12a operates without fail in the case of priming on a sheet of paper.

Line sensor 13a senses use of a telephone line. Line sensor 13a senses a change in voltage on a telephone line, for example. Line sensor 13a reacts when the voltage on a telephone line changes. Accordingly, when image data is transmitted to and received from another facsimile machine, line sensor 13a operates without fail.

Box sensor 14b senses that the image data of the document read by document reader 10 and the image data received front another device has been stored in box area 14a. Box sensor 14b senses lamp light that lights up, for example, when the image data of the document read by document reader 10 or the image data received from another device is stored in box area 14a. Accordingly, box sensor 14b operates without fail when the image data of the document read by document reader 10 or the image data received from another device is stored in box area 14a.

Authentication sensor 17a senses the authentication operation by a user. When authentication is performed through an input of an ID or a password into operation panel 16, authentication sensor 17a senses a change in pressure occurring when an authentication button is pressed. When authentication is performed by an IC card, authentication sensor 17a senses the radio wave generated when an IC card is held over an IC card reader. Thus, when the user performs an authentication operation, authentication sensor 17a operates without fail.

Thus, based on which sensor among the above-mentioned sensors operates, it can be specified which function is performed.

When both reading sensor 10a and conveyance sensor 12a have operated, it can be recognized that reading of the document by document reader 10 and printing on a sheet of paper have been performed. Thus, function specifying unit 21f determines that the copy function of printing the image of the document read by document reader 10 on a sheet of paper has been performed. Then, function specifying unit 21f specifics the function of the application as a copy function.

Furthermore, when reading sensor 10a has not operated but conveyance sensor 12a has operated, it can be recognized that reading of the document by document reader 10 has not been performed, but only printing on a sheet of paper has been performed. Thus, function specifying unit 21f determines that the print function of printing an image received from another device on a sheet of paper has been performed. Then, function specifying unit 21f specifics the function of the application as a print function.

Furthermore, when reading sensor 10a has operated but conveyance sensor 12a has not operated, it can be recognized that reading of the document by document reader 10 has been performed, but printing on a sheet of paper has not been performed. Thus, function specifying unit 21f determines that the scan function of converting the image of the document read by document reader 10 into electronic data has been performed. Then, function specifying unit 21f specifics the function of the application as a scan function.

Furthermore, when line sensor 13a has operated, it can be recognized that the voltage on the telephone line has changed. Thus, function specifying unit 21f determines that the facsimile function of transmitting and receiving the image data to and from another facsimile machine through a telephone line has been performed. Then, function specifying unit 21f specifies the function of the application as a facsimile function.

Furthermore, when box sensor 14b has operated, it can be recognized that the image data of the document read by document reader 10 or the image data received from another device is stored in box area 14a. Thus, function specifying unit 21f determines that the box function of causing box area 14a to permanently or temporarily store the image data of the document read by document reader 10 or the image data received from another device has been performed. Then, function specifying unit 21f specifies the function of the application as a box function.

Furthermore, when authentication sensor 17a has operated, it can be recognized that a user has performed the authentication operation. Thus, function specifying unit 21f determines that the authentication function of verifying whether the user of image forming apparatus 100 is a valid user or not has been performed. Then, function specifying unit 21f specifics the function of the application as an authentication function.

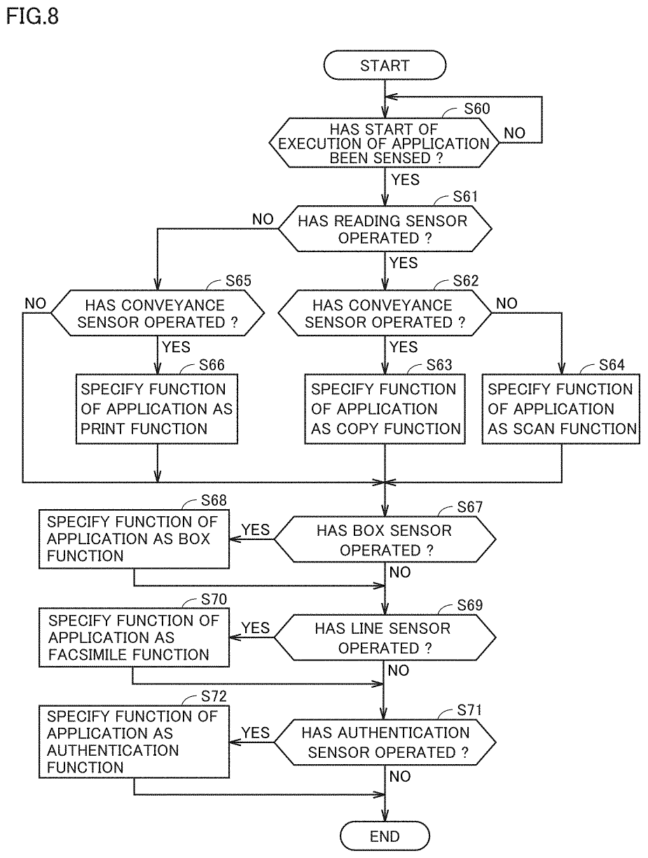

Then, referring to FIG. 8, an explanation will be given with regard to the flow of the process in which function specifying unit 21f specifies the Junction of the application based on the operation status of a sensor. FIG. 8 is a flowchart illustrating the process of specifying a function of an application in the third embodiment.

First, function specifying unit 21f determines whether execution of the application has been started or not (step S60). Function specifying unit 21f repeats the process of step S60 until execution of the application is started. When execution of the application is started, (YES in step S60), the process proceeds to step S61.

In step S61, function specifying unit 21f determines whether reading sensor 10a has operated or not. When reading sensor 10a has operated (YES in step S62), function specifying unit 21f proceeds the process to step S62. On the other hand, when reading sensor 10a has not operated (NO in step S61), function specifying unit 2 If proceeds the process to step S65.

In step S62, function specifying unit 21f determines whether conveyance sensor 12a has operated or not. When conveyance sensor 12a has operated (YES in step S62), function specifying unit 21f specifies the function of the application as a copy function (step S63), and then proceeds the process to step S67. On the other hand, when conveyance sensor 12a has not operated (NO in step S62), function specifying unit 21f specifies the function of the application as a scan function (step S64), and then proceeds the process to step S67.

In step S65, function specifying unit 21f determines whether conveyance sensor 12a has operated or not. When conveyance sensor 12a has operated (YES in step S65), function specifying unit 21f specifies the function of the application as a print function (step S66). On the other hand, when conveyance sensor 12a has not operated (NO in step S65), function specifying unit 21f proceeds the process to step S67 without specifying the function of the application.

In step S67, function specifying unit 21f determines whether box sensor 14b has operated or not. When box sensor 14b has operated (YES in step S67), function specifying unit 21f specifics the function of the application as a box function (step S68), and then proceeds the process to step S69. On the other hand, when box sensor 14b has not operated (NO in step S67), function specifying unit 21f proceeds the process to step S69 without specifying the function of the application as a box function.

In step S69, function specifying unit 21f determines whether line sensor 13a has operated or not. When line sensor 13a has operated (YES in step S69), function specifying unit 21f specifies the function of the application as a facsimile function (step S70), and then proceeds the process to step S71. On the other hand, when line sensor 13a has not operated (NO in step S69), function specifying unit 21f proceeds. The process to step S71 without specifying the function of the application as a facsimile function.

In step S71, function specifying unit 21f determines whether authentication sensor 17a has operated or not. When authentication sensor 17a has operated (YES in step S71), function specifying until 21f specifics the function of the application as an authentication function (step S72), and ends the process. On the other hand, when authentication sensor 17a has not operated (NO in step S71), function specifying unit 21f ends the process without specifying the function of the application as on authentication function.

Through the above-described process performed by function specifying unit 21f, the function of the application is specified by the sensor that has operated in accordance with execution of the application. For example, with reference to application 500 as an example, when, in accordance with execution of application 500, reading sensor 10a has not operated (NO in step S61) bill conveyance sensor 12a has operated (YES in step S65), function specifying unit 21 f specifies the function of application 500 as a print function (step S66). Furthermore, when authentication sensor 17a has also operated (YES in step S71) in accordance with execution of application 500, function specifying unit 21f specifics the function of application 500 as an authentication function (step S72). As a result, function specifying unit 21f specifics the function of application 500 as a print function and an authentication function.

In this way, image forming apparatus 100 according to the third embodiment specifies the function of the application based on the operation statuses of various sensors that have operated in accordance with execution of the application. Thus, image forming apparatus 100 according to the third embodiment can specify the function of the application even when the firmware to be accessed cannot be specified based on the description content of the program of the application and the invoked API. The sensors are not limited to those as described above, but each may be hardware associated with a function in one-to-one relation or may be a plurality of pieces of hardware combined with one another to be capable of specifying one function.

As above, image forming apparatus 100 according to the third embodiment has been described. According to the third embodiment, the function of the application is specified based on the operation statuses of various sensors that have operated in accordance with execution of the application, and then, the user is notified about the specified function in association with the application. As a result, not only the person who has downloaded the application but also another user other than this person can select his/her desired application after understanding the function of each application.

### Fourth Embodiment

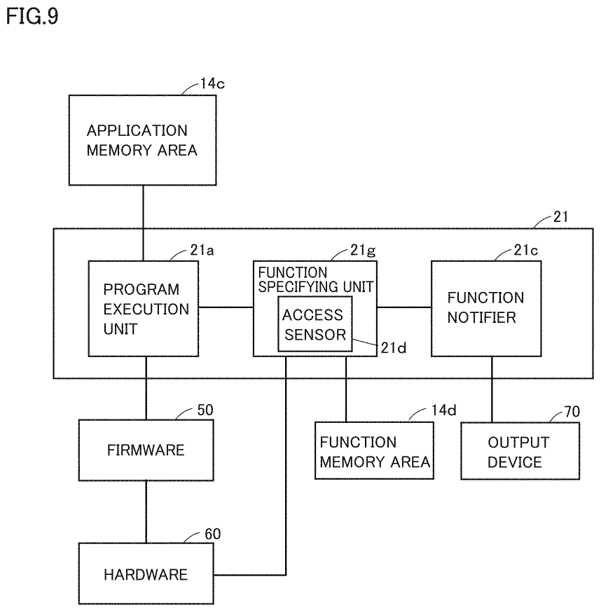

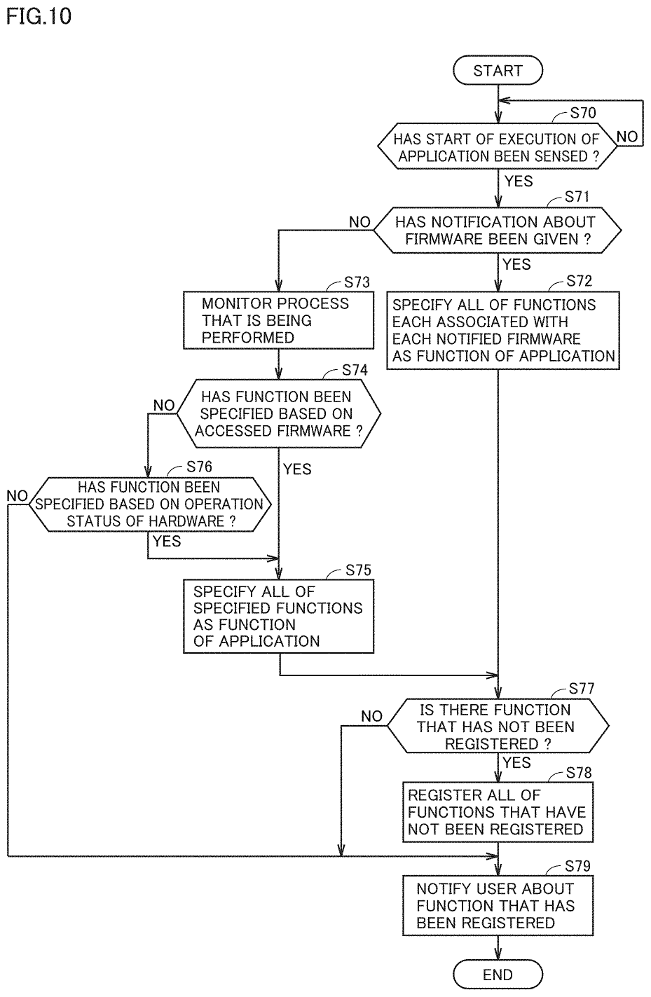

Thus, the first to third embodiments have been described as above. The first to third embodiments may be arbitrarily combined with one another. In the fourth embodiment, the case where all of the first to third embodiments are combined will be described. FIG. 9 is a block diagram showing the structure of a controller 21 of an image forming apparatus 100 according to the fourth embodiment. Controller 21 in the fourth embodiment includes: a program execution unit 21a that executes a program of an application; a function specifying unit 21g that specifics the function of the application; and a function notifier 21c that notifies a user about the function of the application, as in the first embodiment. On the other hand, controller 21 in the fourth embodiment is different from that in the first embodiment in that function specifying unit 21g includes access sensor 21d for sensing access to firmware 50, and that function specifying unit 21g is associated also with hardware 60. Referring to FIG. 10, an explanation will be hereinafter given with regard to the flow of the process in controller 21 in which, in accordance with the start of execution of the application, function specifying unit 21g specifics the function of the application, and function notifier 21c notifies the user about the specified function. The process of registering the specified function in function memory area 14d, the process performed in program execution unit 21a, and the process performed in function notifier 21c are the same as those in the first embodiment, and therefore, the description thereof will not be repeated.

FIG. 10 is a flowchart for illustrating the process in a controller 21 of an image forming apparatus 100 according to the fourth embodiment. The process in steps S70 to S78 shows the process in function specifying unit 21g of controller 21. The process in step S79 shows the process in function notifier 21c of controller 21.

First, function specifying unit 21g determines whether execution of the application has been started or not (step S70). Function specifying unit 21g repeats the process of step S70 until execution of the application is started. When execution of the application is started (YES in step S70), the process proceeds to step S71.

Then, function specifying unit 21g determines whether a notification about firmware 50 to be accessed has been given or not (step S71). When a notification about firmware 50 to be accessed has been given (YES in step S71), function specifying unit 21g specifics all of the functions each associated with each notified firmware 50 as a function of the application (step S72), and then proceeds the process to step S77. On the other hand, when a notification about firmware 50 to be accessed has not been given (NO in step S71), function specifying unit 21g monitors the process that is being performed (step S73).

The process in step S72 is specifically to specify firmware 50, which is to be accessed, based on the description content of the program of the application and to specify the function associated with this firmware 50 as a function of the application, as having been described in the first embodiment.

Then, function specifying unit 21g determines whether the function of the application has been specified or not based on the accessed firmware (step S74). When the function of the application has been specified based on the accessed firmware (YES in step S74), function specifying unit 21g proceeds the process to step S75. On the other hand, when the function of the application cannot be specified based on the accessed firmware (NO in step S74), function specifying unit 21g proceeds the process to step S76.

In step S76, function specifying unit 21g determines whether the function of the application has been specified or not, based on the operation status of hardware 60. When the function of the application has been specified based on the operation status of hardware 60 (YES in step S76), function specifying unit 21g proceeds the process to step S75. On the other hand, when the function of the application cannot be specified based on (he operation status of hardware 60 (NO in step S76), function specifying unit 21g proceed the process to step S79.

In step S75, function specifying unit 21g specifies all of the functions specified in steps S74 and S76 as functions of the application.

The process from steps S74 to S75 is specifically to specify the accessed firmware 50 based on the API invoked during execution of the program of the application and to specify the function associated with firmware 50 as a function of the application, as having been described in the second embodiment.

Furthermore, the process from steps S76 to S75 is specifically to specify the function of the application based on the operation status of hardware 60 that has operated in accordance with execution of the application, as having been described in the third embodiment.

In step S77, function specifying unit 21g determines whether or not there is a function, among the functions specified in step S72 or step S75, that has not been registered in function memory area 14d as a function of the application. When there is a function that has not been resisted (YES in step S77), function specifying unit 21g registers all of the functions, which have not been registered, as functions of the application in function memory area 14d (step S78), and then proceeds the process to step S79. On the other hand, when there is no function that has not been registered (NO in step S77), function specifying unit 21g proceeds the process to step S79 without registering a function in function memory area 14d.

In step S79, function notifier 21c notifies the user about the function, which has been registered in function memory area 14d. In association with the application, and then ends the process.

The process in step S79 is specifically it notification through operation panel 16, a notification through an e-mail, a notification by a sound, and the like, as having been illustrated with reference to FIGS. 4A, 4B, 4C, and 4D. By the process in steps S77 to S79 by controller 21, even the function that has not been performed during previous execution of the application but that is performed by the current execution of the application is additionally registered in function memory area 14d, and then, a notification thereof is given to the user. Thereby, the user can always obtain the latest information about the function of the application.

As above, the process for specification and notification about the function of the application in image forming apparatus 100 according to the fourth embodiment has been described. According to the fourth embodiment, in accordance with execution of the application, the function of the application is specified based on the description content of the program of the application, the firmware to be accessed or the operation status of the hardware. Then, the user is notified about the specified function in association with the application. As a result, not only the person who has downloaded the application but also another user other than this person can select his/her desired application after understanding the function of each application.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus comprising:
a receiver that receives an application from outside; and
a controller for controlling the image forming apparatus, wherein
the controller performs operations including
executing the application received by the receiver,
specifying a function of the application based on execution of the application, and
outputting the specified function of the application in a state where the application is associated with the specified function of the application.

2. The image forming apparatus according to claim 1, wherein the specifying a function of the application includes specifying the function of the application based on a program associated with the application.

3. The image forming apparatus according to claim 2, wherein the specifying a function of the application includes specifying the function of the application based on a content of an execution instruction in the program associated with the application.

4. The image forming apparatus according to claim 2, wherein
the controller further performs an operation including sensing access to firmware of the image forming apparatus, wherein
the specifying a function of the application includes specifying the function of the application based on the firmware to which access is sensed when the application is executed.

5. The image forming apparatus according to claim 1, wherein the specifying a function of the application includes specifying the function of the application based on an operation status of hardware occurring when the application is executed.

6. The image forming apparatus according to claim 5, wherein
the hardware includes
a job sensor that senses execution of a job by the image forming apparatus, and
an authentication sensor that senses all authentication operation by a user.

7. The image forming apparatus according to claim 6, wherein
the job sensor includes
a reading sensor that senses reading of a document image,
a conveyance sensor that senses conveyance of a sheet of paper,
a line sensor that senses use of a telephone line, and
a box sensor that senses use of a box area in which electronic data is stored, and
the specifying a function of the application includes
specifying the function of the application as a copy function when both the reading sensor and the conveyance sensor operate based on execution of the application,
specifying the function of the application as a print function when the conveyance sensor operates and the reading sensor docs not operate based on execution of the application,
specifying the function of the application as a scan function when the reading sensor operates and the conveyance sensor does not operate based on execution of the application,
specifying the function of the application as a facsimile function when the line sensor operates based on execution of the application, and
specifying the function of the application as a function of using a box area when the box sensor operates based on execution of the application.

8. The image forming apparatus according to claim 6, wherein the specifying a function of the application includes specifying the function of the application as an authentication function when the authentication sensor operates based on execution of the application.

9. The image forming apparatus according to claim 1, further comprising a memory in which the specified function of the application is stored in association with the application, wherein
the outputting the specified function of the application includes outputting the function of the application based on the application and the function that is stored in association with the application.

10. The image forming apparatus according to claim 9, wherein
the specifying a function of the application includes, when the application includes a plurality of functions, specifying the plurality of functions, and
the memory stores all of the plurality of specified functions in association with the application.

11. The image forming apparatus according to claim 9, wherein
when the function specified based on execution of the application is different from the function stored in association with the application, the memory further stores the specified function in association with the application.

12. The image forming apparatus according to claim 1, wherein
the outputting the specified function of the application includes at least one of
displaying the specified function on an operation panel,
outputting the specified function by a sound, and
outputting textual information indicating the specified function.

13. A non-transitory computer-readable recording medium storing a program for controlling an image forming apparatus, the program causing a computer to perform:
receiving an application from outside;
executing the application received;
specifying a function of the application based on execution of the application; and
outputting the specified function of the application in a state where the application is associated with the specified function of the application.

14. A method of controlling an image forming apparatus, the method comprising:
receiving an application from outside;
executing the application received;
specifying a function of the application based on execution of the application; and
outputting the specified function of the application in a state where the application is associated with the specified function of the application.

15. The method according to claim 14, wherein the specifying a function of the application includes specifying the function of the application based on a program associated with the application.

16. The method according to claim 14, wherein the specifying a function of the application includes specifying the function of the application based on an operation status of hardware occurring when the application is executed.

17. The method according to claim 14, further comprising storing the specified function of the application in association with the application, wherein
the outputting the specified function of the application includes outputting the function of the application based on the application and the function that is stored in association with the application.

18. The method according to claim 17, wherein
the specifying a function of the application includes, when the application includes a plurality of functions, specifying the plurality of functions, and
the storing the specified function of the application in association with file application includes storing all of the plurality of specified functions in association with the application.

19. The method according to claim 17, wherein the storing the specified function of the application in association with the application includes, when the function specified based on execution of the application is different from the function stored in association with the application, further storing the specified function in association with the application.

20. The method according to claim 14, wherein
the outputting the specified function of the application includes at least one of
displaying the specified function on all operation panel,
outputting the specified function by a sound, and
outputting textual information indicating the specified function.
